(19) United States
(12) Patent Application Publication
(10) Pub. No.: US 2010/0116647 A1
(43) Pub. Date: May 13, 2010

(54) BALLAST WATER TREATMENT PLANT HAVING FILTER, DISINFECTION, INSTRUMENTATION AND CONTROL UNIT

(76) Inventors: Anja Kornmuller, Bremen (DE); Helmut Josef Werle, Bremen (DE)

Correspondence Address: Law Offices of Robert F. Zielinski, LLC, 1518 Walnut Street, Suite 1706, Philadelphia, PA, 19102, US

(21) Appl. No.: 12/442,644

(22) PCT Filed: Aug. 14, 2007
(86) PCT No.: PCT/EP07/07161

§ 371 Date: Jan. 6, 2010

(30) Foreign Application Priority Data
Sep. 25, 2006 (DE) 10 2006 045 558.4

(51) Int. Cl. C02F 1/467

(52) U.S. Cl. 204/228.1; 210/96.1

(57) ABSTRACT

Water treatment plant, in particular ballast water treatment plant, for removing sediments and/or removing and/or destroying living organisms, which has at least one filter unit (B) and at least one disinfection unit (C), wherein the plant has a detection unit (D) by means of which the number of living organisms of a presettable size per unit volume of water can be determined, and in that the plant has a control unit, by means of which the disinfection unit (C) can be controlled as a function of the number of living organisms which has been determined.

The invention relates to a water treatment plant, in particular a ballast water treatment plant, for removing sediments and/or removing and/or destroying living organisms, which has at least one filter unit and at least one disinfecting unit.

The transport of invasive organisms with ballast water represents one of the greatest threats to the ocean. To stabilize the position, ships must take on ballast water when they are not loaded or not completely loaded. Ships transport sediments and organisms in the ballast water, such as, e.g., algae, and release the latter when dumping in the port/region of arrival. Depending on the trip route of the ship, the latter do not naturally occur in this field, can penetrate as invasive organisms in suitable living conditions and absence of natural foes, and thus lead to considerable ecological, economical and health damage.

The current practice of ballast water management is the ballast water exchange on the high seas, whereby the water of the port is displaced from the ballast water tank by means of sea water. To this end, now either the pump-through method is used or the tank is first emptied and then refilled with sea water. The scientific background is the assumption that because of the different living conditions, organisms from the port do not survive in the open sea and vice versa. This is not always a given, however, in the case of a wide tolerance range of the organism, and the exchange can never take place completely based on the angled ballast water tank design. Moreover, it is very time-consuming, e.g., it can take days in the case of a large crude oil tanker with 1,000,000 tons of ballast water on board. Frequently, for reasons of the safety of the ship and the crew, e.g., in poor weather conditions, the exchange on the high seas is completely abandoned.

It is therefore necessary to replace the thus far common ballast water exchange by an efficient ballast water treatment on board ships in order to prevent further worldwide spreading of invasive organisms by the transport in ballast water.

In addition to the high biological action, the main requirement is that the treatment process in the operation of the ship and the ballast water system be integrable. In this connection, it is important that the ballast water treatment operate interruption-free with a high volumetric flow rate in the range of 50-7000 m³/h. Additional requirements are a high degree of automation, low maintenance requirement, suitable material selection, no build-up of corrosion by the disinfection process as well as consideration of the installation situation on board.

In comparison to the present onboard ballast water systems, in which there are pipeline systems for filling and emptying the ballast water tank, it must be considered in the installation of treatment systems that a portion of the purified water is used to desludge the separator, e.g., to backwash the filter. So as not to lengthen the period of ballast water removal and thus the idle period of the ship, it is necessary to select separators that have a high ballast water net production even with high sediment contents in the ballast water.

The ballast water treatment plant must be able to deal with all water qualities that occur worldwide. The biological and chemical-physical water quality is exposed to great geographic, climatic and seasonal fluctuations.

Ballast water can consist of stream water, brackish water and sea water and thus allows in an extraordinarily large number of organisms that must be removed and/or destroyed in the ballast water treatment. The relevant organism groups comprise fish, mollusks, and shellfish, zoo plankton, phytoplankton, cysteine, bacteria as well as viruses.

With chemical-physical water parameters, in particular the particle size distribution and the suspended sediment concentration (measuring parameters: substances that can be filtered) are decisive for treatment. In addition to the above-mentioned influence factors, the latter depend in addition on the local conditions at the site of the ballast water uptake, such as wind and tide effect, adjacent ship movements, and use of the drive and the lateral thrust unit, which result in the swirling-up of deposited sediments and thus increased concentrations. In particular, in the tide-affected ports, very high sediment concentrations occur.

Plants with one or more larger mechanical separators, which, however, prove unsuitable for the onboard design situation and exceed, e.g., the common deck height of 2.5 m, are known. The deposit of sediments in the ballast water tank brings about high costs because of the loss of cargo capacity and tank purification. Some plants have a high pressure loss or require a high delivery pressure of the ballast water pump. The delivery levels of present ballast water pumps are in the range of 1.5-4 bar and can increase the latter only to a limited extent. The use of UV systems for disinfecting ballast water (WO 02/074 692) is not suitable because of the low transmission of the water.

The use of cavitation for disinfection, e.g., produced by changes in the flow profile (WO 2005/108 301) or by ultrasound (WO 2005/076 771) in the pipeline, requires a very high energy expenditure and is always associated with material damage, e.g., in the pipelines, because of the active forces.

Other known disinfection processes, such as the use of ozone (WO 2006/086 073) or chlorine dioxide (WO 02/44089), require that these substances have to be produced laboriously on board. In the case of chlorine dioxide, the mixture of two hazardous chemicals before addition is necessary. With ozone, there is also a health risk for the crew. Ozone emits gas from the water and since the ballast water tanks are not closed containers but rather have outgoing air hoses, the toxic ozone gas can get into the surrounding atmosphere. Moreover, it is still not finally clarified whether ozone produces intensified corrosion on the materials that are used in the ballast water pipeline and tank system. Based on the pH of between 7-8.5 in the sea water, the formation of cancer-causing bromate can occur because of the higher bromide concentration in the ozonization.

In the addition of pesticides as finished commercially available chemicals (EP 1 006 084, EP 1 447 384), it has to be considered that the latter require a certain exposure time in the range of hours to days and also have action only for a certain time. If the duration of action in the ballast water tank is shorter than the travel period, the pesticide optionally has to be applied again on board. If the duration of action has not elapsed, however, and thus the pesticide is still not consumed, the ballast water still must not be released for environmental reasons. Here, excessive restrictions on ballast water operations can arise.

Conventional chlorine electrolyses require a minimum conductivity in water for the production of disinfecting agents (e.g., WO 2005 061 394). Since most ships are designed for worldwide travel, an application in stream water (fresh water) is not possible here. With low conductivities in stream water, the disinfecting agent first has to be produced from a saline spring (WO 03/023 089) or by adding salt (US 2006/0113257) by means of electrolysis. This procedure has the drawback that chemicals have to be delivered onboard, stored, and prepared manually before the addition.

In addition, it is disadvantageous that the residual chlorine that is produced in conventional electrolysis must not be released directly with the ballast water into the environment. Either a holding time must be maintained before the water on board is discharged until the residual concentration has dropped toward zero (WO 2006/003 723) or the residual chlorine concentration has to be destroyed by adding a reducing agent, e.g., sodium sulfite (US 2006/0113257) or sodium thiosulfate (WO 2004/054 932). This makes the delivery logistics, storage, handling, and metering, of another chemical on board necessary.

Usually, the metering of disinfecting agents is carried out in the water treatment in proportion by volumetric flow rate (EP 1 447 384) or based on the online measurement of the concentration of the disinfecting agent during discharge and corresponding readjustment of the disinfection process (US 20060113257, WO2005061394). In this connection, the direction action of the treatment, such as the destruction of living organisms, is not detected.

It is disadvantageous that the metering in proportion to volumetric flow rate allows only a constant dose ratio, but the fluctuations in water quality and thus the resulting different rates of attrition of disinfecting agents in water are not taken into consideration.

The usual online measuring procedures for regulating the disinfection processes are based on the measurement of the disinfecting agent concentration after the treatment is completed. To this end, in most cases, potentiostatic measuring cells are used with a sensor in the bypass to the main stream, whereby the concentration of the oxidizing agent chlorine (free and/or total chlorine), chlorine dioxide, ozone, bromine but also OH radicals is determined online and is used as a set value for the disinfection. An integrated filter in front of the sensor is to prevent malfunctions but easily clogs. In the measurement of solid- and algae-containing surface water, the collection of particles and biofouling in the measuring cell result, which leads to additional consumption of disinfecting agent and thus can falsify the measurement. To avoid this, higher maintenance costs are necessary, which in general cannot be supplied because of the small number of crew members on board. If several oxidizing agents are present in the water at the same time, no difference between the disinfecting agents is possible, and a residual concentration of all oxidizing agents is detected.

The monitoring of the operation of present ballast water systems is carried out via measurements of volumetric flow rate and/or fill-level measurements in the ballast water tank and corresponding data storage. The change in fill level is used in a known ballast water treatment process to demonstrate that the ballast water tank was emptied and released via pumps (WO 2005/10830). This is not an indication, however, that the ballast water was also treated.

The object of the invention is to provide a water treatment plant, in particular a ballast water treatment plant, for removing sediments and/or removing and/or destroying living organisms, which overcomes these drawbacks and ensures a reliable water treatment while maintaining prescribed standards relative to the number of living organisms per unit of volume of the water, which is met in ships in particular in the requirements imposed on a ballast water treatment plant.

This object is achieved according to the invention by a water treatment plant according to claim 1.

It is especially advantageous in this case that the plant has a detection unit, by means of which the number of living organisms of a prescribed value can be determined per unit of volume of water and that the plant has a control unit, by means of which the disinfecting unit can be controlled based on the determined number of living organisms.

By determining the actual number of living organisms of a presettable value per unit of volume of the water, it thus is possible to regulate the disinfecting unit exactly, i.e., that neither too low a disinfection nor too high a disinfection of the water is carried out. The plant is not limited to the treatment of ballast water; in general, it can also be used in the treatment of service water both on board ship and on shore. By determining the number of living organisms per unit of volume of water, which then forms the basis of the regulation of the disinfecting unit, it is possible to match the plant to the stepped-up environmental standards and to maintain presettable standards, in particular for maintaining the IMO Performance Standard D2, with which internationally binding standards are prescribed for introducing ballast water into the environment.

Additional advantageous embodiments are indicated in the subclaims.

The detection unit is preferably downstream from the disinfecting unit. In this connection, it is possible to determine directly the water quality of the water that exits from the disinfecting unit.

It is especially advantageous when the detection unit has a fluorometer for detecting living phytoplankton cells and/or microorganisms, by means of which the minimum fluorescence and the maximum fluorescence can be determined relative to a unit by volume of water and which has an evaluating unit, by means of which a calculation of the variable fluorescence as well as a calculation of the number of living phytoplankton cells and/or microorganisms of one reference species can be implemented.

In this case, the minimum fluorescence Fo refers to the fluorescence from living and dead cells, the maximum fluorescence Fm corresponds to the fluorescence in which at least approximately all primary electron acceptors are reduced, and the variable fluorescence Fv corresponds to the difference between the maximum fluorescence Fm and the minimum fluorescence Fo, in each case relative to the water and/or organisms that are found in the measuring chamber, which is to be examined.

To determine living cells or organisms in water, the fluorescence can be detected by means of a fluorometer. In this case, two states can be distinguished, on the one hand, the minimum fluorescence Fo (dark state) and the maximum fluorescence Fm in an introduction of light, in particular light of a prescribed wavelength. It has been shown, surprisingly enough, that the difference of maximum fluorescence Fm minus the minimum fluorescence Fo, i.e., the variable fluorescence Fv, is a measure for the number of living phytoplankton cells and/or microorganisms in the measuring chamber or the quantity of water and/or organisms tested, since the variable fluorescence Fv and the number of living cells correlate.

The number of living phytoplankton cells and/or microorganisms of a reference species in the measuring chamber or the quantity of water and/or organisms tested can be calculated by a measurement of minimum fluorescence Fo (without illumination), a measurement of the maximum fluorescence Fm (with illumination) as well as the calculation of the variable fluorescence Fv by forming the difference of Fm minus Fo.

As an alternative or cumulatively to the calculation of the variable fluorescence Fv by forming the difference of maximum fluorescence Fm minus minimum fluorescence Fo, it is also possible to detect the dynamic plot of a fluorescence induction curve in a measuring chamber, in particular by a partial or complete detection of the time plot of the fluorescence induction curve and obtaining the missing information by interpolation by means of a mathematical model.

The intensity of the fluorescent light is directly proportional to the number of cells of a reference species in the respective measuring chamber of the quantity tested in/out of the water, i.e., the relation follows a straight line, whereby the slope of the lines of proportionality are in turn a measure of the sizes of the individual cells.

Preferably, the detection unit has a fluorometer for detecting living phytoplankton cells and/or microorganisms, whereby the fluorometer has at least one light source and at least one detector.

The detection unit preferably has a testing chamber that is formed by a cuvette, in particular made of glass or plastic.

The “testing chamber” can be a test volume that is filled with the water that is to be examined, i.e., a water sample, but it can also be a membrane filter, by means of which a specific amount of the water that is to be examined was filtered, and whereby the measurement of the minimum fluorescence Fo and the maximum fluorescence Fm is carried out directly with the cell layer on the surface of the membrane filter without water.

It is advantageous if the detection unit has at least one pulsating light source and/or at least one continuous light source, in particular LEDs.

The detection unit preferably has several light sources, in particular at least one light source with pulsating light, in particular blue light with a wavelength of approximately 420 nm and/or at least one light source of continuous light, in particular red light with a wavelength of 660 nm, and/or a light source with a wavelength of more than 700 nm.

Preferably, a storage unit is arranged, by means of which the determined number of living organisms per unit of volume of water can be stored in a volatile or permanent manner, in particular for documentation purposes. In this respect, documentation that can be examined is made possible.

The detection unit can be connected to the control unit and a storage unit of the plant. This thus makes possible the detection of successful treatment. In addition to information such as the duration and the type of ballast water operation (ballast water uptake or discharge), the latter can be used as identification in the so-called Ballast Water Record Book.

Preferably, the plant has an interface to a positioning system and/or navigation system.

In a preferred design, the water treatment unit, in particular the control unit of the water treatment plant, is coupled to a control system of the ship and/or to the GPS (Global Positioning System) of the ship, e.g., by a navigation system.

As an alternative, the data can also be called up via satellite link, transmitted, and stored and processed externally. In all cases, it is possible to detect at what position, with which treatment efficiency and in what quantity water or ballast water was taken up or treated water or ballast water was released into the environment. This facilitates possible controls of the legal requirements, e.g., in seaport controls.

Preferably, the filter unit has several filters that are arranged in a series and/or in parallel, in particular backwashable filters. In this respect, it is possible to increase the quality of the filtering and/or to filter high volumetric flows.

The filter unit preferably has at least two fine filters, connected in parallel, with a nominal fineness of filtration of less than or equal to 50 μm.

In particular, in the arrangement of several parallel filters, the filter unit can be operated such that at least one filter is used for filtering the water that is to be treated, while at the same time, a parallel filter is cleaned in backwash operation. With several filters, the filter unit can be operated in such a way that each individual filter is backwashed in the filter operation after an operating time, while at the same time in at least one parallel filter, in addition water is filtered. In this way, a uniform backwash of each individual filter can be carried out, by which a uniform quality of the filtering can be ensured and clogging or damage is prevented by the filters that are connected in parallel in each case being individually backwashed in succession.

The filter unit preferably has at least one hydrocyclone, in particular several hydrocyclones that are connected in parallel, in particular (a) hydrocyclone(s) with a separating grain of 30 μm to 60 μm.

The filter unit preferably has at least one coarse filter, in particular a coarse filter with a nominal fineness of filtration of more than 50 μm.

The more thorough separation of particles and organisms for easing the burden of the subsequent disinfection and reduction of the consumption of the disinfecting agents is possible because of the mechanical preliminary separation. Moreover, some organisms, such as resistant dormant stages, have to be mechanically separated in advance, since the latter are not sufficiently damaged by disinfecting agent alone.

Preferably, at least one pressure sensor is arranged, by means of which the pressure drop can be determined via the filter unit.

Backwashing of the filter(s) preferably is carried out when exceeding a presettable standard for a pressure drop via the filter unit and/or following a presettable period of time.

Backwashing of the filter(s) preferably is carried out by means of a backwash pump, in particular with a high backwash water pressure, in particular with a backwash water pressure of 4 bar to 7 bar.

In a preferred embodiment, the filter unit has several filters that are connected in parallel, whereby each individual filter can be turned on or off with a controllable valve.

Preferably, the filter unit is connected via at least one controllable valve to an untreated water line, whereby the untreated water line forms a bypass when the valve is closed.

A feed pump is preferably provided; in particular it is advantageous when a feed pump is placed upstream from the filter unit.

Preferably, a backwash pump is provided. Such a backwash pump feeds water in the backwashing operation of the delivery. The backwash and thus the purification action, in particular of the filter, is all the more effective, the higher the backwash water pressure is.

Preferably, the plant has at least one tank, in particular a ballast water tank.

Backwashing of the plant or individual components of the plant is preferably carried out with potable water and/or with industrial water and/or with plant-treated water.

Preferably, a storage tank is provided to take up backwashed filter sludge. As an alternative, however, an introduction of backwashed filter sludge into the environment can also be carried out, since in the case of a ballasting, the filter sludges contain only those organisms from the immediate surroundings.

The plant preferably has a bypass that can be shut off Such a bypass allows a bypass emergency operation of the plant to be able to ensure the safety of the ship and to make possible a ballasting of the ship at any time upon the failure of one or more components, e.g., by a clogging, which requires manual purification.

Preferably, at least one sensor is provided for measuring the volumetric flow rate; in particular, a sensor can be provided to measure the volumetric flow rate in an untreated water line.

Preferably, a sensor for measuring the volumetric flow rate is provided in a discharged water line and/or in a backwash water line.

The disinfection preferably takes place without the outside addition of chemicals. By eliminating the addition of chemicals for disinfecting the water, a transport that is associated with danger as well as the handling and application of dangerous chemicals in gaseous, liquid or solid form is not necessary.

Preferably, the disinfecting unit has at least one electrolysis cell, which can be controlled based on the determined number of living organisms, in particular living phytoplankton cells and/or microorganisms.

In a preferred embodiment, the disinfecting unit has several switchable, parallel strands with at least one electrolysis cell in each case. By the parallel switching of several strands, very high volumetric flow rates can be achieved, which allow for an effective and quick ballasting and deballasting.

Preferably, short-lived oxidation products, which allow for a direct introduction of the treated water into the environment, can be produced by means of the disinfecting unit.

The plant preferably has a degassing and/or ventilating device; in particular, a degassing and/or ventilating device can be downstream from the disinfecting unit.

Preferably, the plant can be operated in a backwash and/or tank-emptying mode, in which a disinfection, which can be controlled based on the number of living organisms of presettable size per unit of volume of the water, determined by means of the detection unit, is carried out by means of the disinfecting unit and/or filtering by means of the filter unit.

Effluent standards can be adhered to by monitoring the water quality and disinfecting the water, since the control of the disinfecting unit, which uses the disinfection of the water in a backwash and/or tank-emptying mode, is carried out based on the number of living organisms of presettable size per unit of volume of the water determined by means of the detection unit, since the residual organism that are found in the water during the filling of the tank may have increased during the storage time in the tank.

Preferably, the plant can be operated in an emergency operation mode, in which at least one ballast water tank is filled via a bypass line while avoiding the filter unit and/or the disinfecting unit and/or the detection unit. As a result, it can be ensured that even if individual components fail, the safety of the ship is not put at risk, since ballasting and deballasting are always possible.

The plant preferably has a modular design, whereby in particular the filter unit and the disinfecting unit in each case form a module. As an alternative, the filter unit can be divided into several modules such as a coarse separator and fine filter.

A better integration of the ballast water treatment plant in the ship and its ballast water system is possible by the modular design. The volume flows that are to be treated can be achieved both by arranging several treatment plants and/or individual treatment aggregates or treatment modules (rough separator, fine filter, electrolysis cells) in parallel.

By the modular design, the plant can be matched specifically to the respective ship in order to make optimum use of the space offered and the pipeline layout. The pressure loss of the plant is very low and is in particular under 1.5 bar, so that ballast water pumps with the now available delivery levels are used, and, in addition, high-mounted ballast water tanks can also be filled. In all components, the aggregate height, including the maintenance height, preferably lies below the standard height between decks of 2.5 m.

The water treatment with use of the water treatment plant according to the invention comprises the following treatment steps:
1. More thorough mechanical separation of particles and sediments and a high number of organisms during the uptake of ballast water;
2. Subsequent disinfection for further reduction of the living organism numbers before the ballast water tanks in the ballast water uptake;
3. Subsequent disinfection during the release of ballast water to maintain prescribed standards or a prescribed discharge standard, in particular for maintaining the IMO Performance Standard D2.

First, a more thorough mechanical separation is carried out using coarse separators, in particular with at least two hydrocyclones that are connected in parallel and/or with at least one coarse filter, and/or at least two fine filters. By the more thorough mechanical separation with nominal fineness of filtration of ≦50 μm in the ballast water uptake, a majority of the organisms, but also sediments and suspended matter, are removed. To this end, a disk filter is preferably used.

The disinfection stage is depressurized by the mechanical pre-separation, which can be designed correspondingly smaller. The disinfection is carried out without adding chemicals to further reduce the number of living organisms before they go into the ballast water tank. Since the residual organisms can proliferate and grow there during the crossing, the disinfection is used again when pumping off the ballast water, since the delivered discharge standards are to be maintained because the international IMO Ballast Water Agreement requires the standard directly at the drainage of the ship.

The backwashing operation of the filter is introduced when a prescribed pressure loss between the inlet and outlet sides is achieved, which is detected by a measurement of the pressure difference. In this case, the backflushing of the first filter housing is introduced via the control device, and then the additional filter housings are washed in succession. As an alternative, the backwashing is carried out when the prescribed pressure difference in a prescribed time interval does not occur after the end of this time interval.

The electrolytic disinfection is installed directly in the ballast water pipeline and occupies only a little more space in diameter than that of the flange with which it is connected to the pipeline. Logistics, handling and addition of chemicals on board is not necessary here, and as a result, the constraints imposed by a short length of time and a small number of crew members in an onboard operation are thus met. The crew does not come into contact with the oxidizing agent by the in-situ production in the pipeline, and there is thus no threat to safety.

In contrast to conventional electrolysis, the electrolysis that is used here can be operated in a manner that is less dependent on the conductivity of the water, in particular with fresh water, in particular with fresh water with an electrical conductivity of 50 mS/m.

A mixture that consists of various disinfecting and oxidizing agents, in particular OH and oxygen radicals and free chlorine, is produced directly in the electrolysis cell. This is advantageous, since because of the great diversity and different sensitivities of the marine organisms, no one disinfecting agent is able to destroy all types of organisms. A specific exposure time does not have to be maintained during the disinfection. The formation of hydrogen and disinfecting by-products is less than in conventional electrolysis systems. The hydrogen that is produced is removed via an aerator and ventilator or via an active degassing/gassing step. The concentration of the disinfecting by-products that are formed is below the values of the WHO Guidelines for Drinking Water Quality.

The electrolysis cell is operated so that the oxidizing agent that is produced can no longer be detected after 5-30 minutes, and the residual concentration corresponds to the natural blank value in water. As a result, the threat to the environment is reduced, and the ballast water can be disinfected a second time in the discharge and introduced directly into the environment. In addition, it can be operated flexibly with various methods for deballasting, e.g., if additional injectors are used to empty the tank.

The direct, near-real-time efficiency regulation of the disinfection by the control based on the detection of living organisms, such as, e.g., algae, in water, prevents higher oxidizing agent concentrations than necessary from being present during discharge; the energy consumption thus drops, and further damage, such as corrosion in subsequent ballast water pipeline and tank systems as well as unnecessarily high oxidizing agent concentrations during discharge into the environment, is avoided. An external addition of reducing agents to destroy the residual concentration of oxidizing agent before the discharge thus is not necessary. By this regulation and the quick break-up of oxidizing agents formed, this water treatment plant can be applied in open systems with direct introduction into the environment. Therefore, the plant can also be used for treating other marine waters, e.g., in applications in offshore industry, cooling water or aquaculture.

The near-real-time monitoring and corresponding regulation of the disinfection via the living number of organisms is advantageous in particular when discharging ballast water in coastal areas, where various uses such as swimming activities, aquaculture, etc., take place. If the disinfection result is not achieved, the danger exists that disease-causing organisms, e.g., vibrio chlorea or toxic dinoflagellates, get into the stretch of water that is used. If, however, too much disinfecting agent is used in the treatment, the danger exists of the formation of possibly toxic disinfection by-products and their direct introduction.

The volume flows are detected via inductive flowmeters and/or pressure gauges. If parallel hydrocyclones are used as coarse separators before the fine filters, the flowmeter is used after a ballast water pump that is usually not speed-regulated for the operation of hydrocyclones in the optimum flow area. A switching-on and -off of individual hydrocyclones can be carried out by flaps corresponding to the volume flow fluctuations, since the removal efficiency of a hydrocyclone greatly depends on the accepted volume flow.

If the current of the electrolysis cell cannot be adjusted any higher, the volume flow, which is detected with the flowmeter after the detection unit, is throttled, and as a result, the efficiency of the disinfection is further increased.

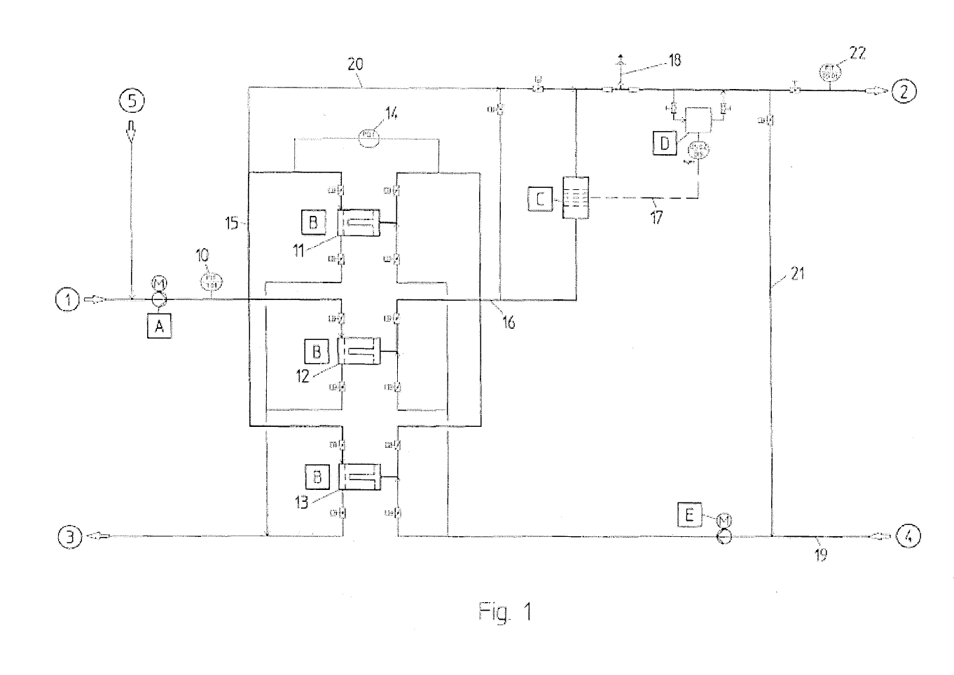

An embodiment of a water treatment plant according to the invention is depicted diagrammatically in FIG. 1 and is explained below.

The water treatment plant according to FIG. 1 is bonded in a ballast water system of a ship and has an untreated-water inflow line 1, which is connected to sea chests. To deliver the sea water, a feed pump A is provided. To determine the volumetric flow rate, a sensor 10 is arranged downstream from the pump A.

The water that is to be treated is directed via a feed line 15 to the filter unit B, which has three filters 11, 12, 13 that are connected in parallel in the embodiment that is depicted. The pressure drop via the filter unit B is determined by means of a pressure sensor 14. If the pressure drop via the filters 11, 12, 13 exceeds a fixed standard, the filters 11, 12, 13 are backwashed individually in succession, while the two other filters in each case further play a role in the filter operation.

The prefiltered water is delivered on to the disinfecting unit C, which has an electrolysis cell, via a collecting pipe 16. The electrolysis cell C is downstream to a detection unit D, by means of which the number of living organisms per liter of water is determined, and which has an evaluating and control unit, whereby the control of the disinfecting unit, i.e., the electrolysis cell C, is carried out via the data line 17 based on the number of living organisms per liter of water.

Between electrolysis cell C and detection unit D, a ventilator 18 is arranged in order to degas the delivered water, in particular to remove from the water the hydrogen that is formed in the electrolysis cell C.

The detection unit D is operated in the bypass flow to the discharge line, since the measurement requires only a small volume of water. Since the measuring signal specifically depends only on the number of living cells, high sediment concentrations do not disrupt this measurement.

The treated, i.e., filtered and disinfected, water is fed to a ballast water tank via the connection 2.

In the backwash line 19, which is connected via the connection 4 to a water tank, not shown, a backwash pump E is provided. The backwash pump E delivers the water in the backwashing of the filters 11, 12, 13, if a backwashing is triggered because of a pressure drop across the filter unit B that is determined to be excessive, as well as the purification of filters 11, 12, 13 when completing the ballasting.

If no fresh water is available for backwashing during the water treatment, a portion of the treated water for backwashing is used in triggering the backwashing via the pipeline 21 and delivered by the backwash pump E. To monitor the volumetric flow rate and to detect the total amount of treated water in the operation of the plant with or without intermittent backwashing or based on very high sediment loads almost constant division of water via the pipeline 21, the volumetric flow rate is detected by means of a sensor 22 before water is fed into the ballast water tank.

The filters 11, 12, 13 are preferably backwashed with water from the discharge of the disinfection D. In this respect, the discharge line is optionally throttled, and the water is directly suctioned off via the pipeline 21 from the backwash pump E. This has the advantage that the discharged water also has a disinfecting action, by which the filters 11, 12, 13 in each backwashing are purified not only mechanically but also chemically, and biofouling is prevented.

For the case that the amount of discharged water is insufficient for backwashing, such as, e.g., for backwashing the last filter unit directly before the shutdown of the operation, water is used externally via the connection 4 without disinfection or via the connection 5 from the ballast water tank with disinfection by delivering water by means of pump A via the bypass 20 to the disinfection unit C.

The feed pump A is also used to deliver the water in a deballasting operation, whereby before the discharge of water to the enviromnent, a renewed disinfection is carried out by means of the disinfecting unit C to remove any cells from the water that have been formed by replication of the residual cells in the ballast water during the storage time to reduce the standard that is to be maintained. For this purpose, a pipeline 21 is provided that is connected so that a backwashing with discharge disinfection can be carried out. To this end, the plant has a connection 5 to the ballast water tank, via which water can be removed from the tank and directed via the treatment plant, i.e., in particular bypassing the filter unit B via the bypass 20 by the disinfecting unit C with renewed disinfection and subsequent checking by means of the detection unit D.

Via the connection 3, the backwashed filter sludges, which accumulate in the ballast water uptake, are released overboard or fed to a storage tank, not shown.

By means of the plant, a treatment of ballast water is thus carried out by filtration and disinfection. In the ballast water uptake, first the sea water that is taken up from the sea chests via the connection 1 is filtered and is disinfected in the connection, and then it is pumped into the ballast water tank via the connection 2. If the ship has to release the ballast water that is taken up, an additional disinfection of the water is performed during deballasting to meet the prescribed discharge standard.

The water treatment plant according to FIG. 1 allows various operational modes, which are explained in more detail below. The functional description of the treatment plant is broken down as follows:
1. Ballast Water Uptake
2. Backwashing the Filter during Ballast Water Uptake (Internal Purification of the Filters)
3. Filter Purification after the Ballast Water Uptake
4. Deballasting
5. Bypass Emergency Operation

### 1^{st} Case: Ballast Water Uptake

The treatment steps of the plant consist of a filtration with filters 11, 12, 13 in the form of disk filters in the filter unit B and a disinfection C, which is based on the electrolysis principle.

The filter unit B is formed from three filters 11, 12, 13, connected in parallel, in the form of disk filters. A disk filter forms the filter surface by means of plastic disks that are pressed to one another. The latter have grooves on the top and bottom. The grooves intersect if the disks lie on one another and thus form an open-pore surface on the outside of the disk packet and breakpoints inside. The depth and arrangement of the grooves in this case determines the nominal fineness of filtration and filter surface area. With this filter, both the surface effect and the low-filtration effect are at work, so that the real fineness of filtration and also the filter surface area are optionally other than nominal.

The disinfecting unit C is integrated in the pipeline and has a somewhat larger periphery than the pipeline itself. By means of the electrolysis principle, it produces oxidative substances from surface water. To this end, four electrode pairs, which are designed as grids, are arranged crosswise to the direction of flow. Electrolysis takes place on the flushing water on these grids. The grids themselves are equipped with a coating that prevents corrosion but at the same time ensures the electrical conductivity. Electrolysis takes place in the low-volt range. Excessive gas formation of hydrogen and oxygen can thus be avoided.

To monitor the result of disinfection, a detection unit D is used. The detection unit D determines photometrically the number of organisms of a reference species of a specific size that are still living during the process of the disinfection. The intensity of the disinfection in the disinfecting unit C is regulated via the detection unit D, which releases a signal from the number of organisms that are still living during the process of the disinfection. This results in the control of the disinfection, in that the current is increased or reduced and thus directly regulates the output of the disinfection in the living organism via the action of the oxidizing substances, which are formed in the electrolysis cell.

The incoming and outgoing volume flows are detected by means of sensors 10, 22, and the pressures are detected via the filter elements 11, 12, 13 by means of a pressure sensor 14. In addition, the determined number of living cells per volume unit of the water is detected by means of the detection unit D. All detected data are documented, i.e., stored.

A monitoring of the releases of individual equipment, plant parts and modules is performed by a higher-level monitoring and control unit. Should, e.g., position feedback indications or measuring devices have false values ahead of time, the corresponding alarms that prevent authorization are generated.

If all necessary authorizations are present, the ballast water uptake begins. To this end, the ballast water pump A is turned on. The ballast water is pumped through the filters 11, 12, 13; then it flows through the disinfection C and from there into the ballast water tank via the connection 2 and/or can be used directly for backwashing, which is necessary during the ballast water uptake if a high sediment load is released, by switching the flaps for backwashing via the pipeline 21. The backwashing is introduced when achieving a prescribed differential pressure or a prescribed time interval. Another description of the backwashing is carried out in Case 2.

2^{nd} Case: Backwashing during the Ballast Water Uptake

The filters 11, 12, 13 are connected in parallel. This has the advantage that one filter can receive further flow while another is being cleaned. For cleaning, the course of disinfection and thus the filtrate from the filters 11, 12, 13 that are still receiving flow are used. For cleaning, the backwash pump E has to be activated. By switching the flaps, the necessary water is prepared and either removed via the connection 4 to a fresh water tank or diverted from the treated water via the pipeline 21. The backwash pump E delivers backwards via the filtrate side with an increased pressure of 6 bar through a filter housing and thus cleans the latter. The sludge is removed overboard via the connection 3 on the untreated water side by a sludge line or intermediately stored in a holding tank.

The purification period can be preset, for example 10 seconds per individual filter 11, 12, 13. If a filter housing is cleaned, the flaps are reset to the filtration position, so the next filter housing can be cleaned. This happens according to a fixed sequence, since the differential pressure that triggers the backwash is determined only via the entire series connection.

In the backwashing, the force on the disks that is applied by a spring tension is achieved by the pressure of the backwash pump. The disks are mounted on a filter installation kit. This filter installation kit has variable spray nozzles that are arranged tangentially around its periphery and through which the backwash water is forced. It thus results in a rotation of disks, which positively supports the cleaning. If the flap of the backwash is closed again, the filter cartridge drops, and the spring force presses the now cleaned disks on one another again.

3^{rd} Case: Filter Purification after the Ballast Water Uptake

After the required amount of ballast water was taken up and before the plant is shut down, the filter housings are cleaned for protection from bacterial contamination and as preparation for other ballast procedures. To this end, untreated water is filtered in addition. The process is distinguished from backwashing in that the filter housing is no longer used for filtration after purification, and in that for this purpose, the disinfection output is set to maximum.

The untreated water is now filtered, passes through the disinfection C, and is fed directly to the backwash pump E via the pipeline 21. A feed into the ballast water tank is no longer provided. As in the normal backwashing, the water is discarded overboard. The purification of the last two filter housings can no longer be performed only with untreated water, since no filter container is available. Nevertheless, to achieve a cleaning, the flap in front of the ballast water pump A is switched. Then, by means of the ballast water pump A, already filtered and disinfected ballast water is removed from a ballast water tank that is placed nearby, or industrial water or potable water that is available on board is sent via the connection 4 without being disinfected or via the connection 5 from the ballast water tank again via the disinfection and used for backwashing.

### 4^{th} Case: Deballasting

To be able to release ballast water, the water is pumped from the ballast water tanks via the connection 5. The filters 11, 12, 13 are circumvented via the installed bypass 20, or the untreated water line of the filters 11, 12, 13, shut off by closing the valves that can be controlled, it itself used as a bypass. The ballast water is now guided directly through the disinfection C and sent over board.

The disinfection is regulated with the signal from the detection unit D, as dictated by the requirements, in order to maintain the discharge standard. For the case that the detection unit D should indicate non-compliance with the prescribed standard and the current cannot be further increased, the dose of the disinfection is additionally increased by increasing the dwell time by means of slowing down the volume flow to be released.

In the ballast water pumps that have to deliver a high volume flow, so-called injectors are used for draining residues from the ballast tanks. They protect the ballast water pumps from cavitation in draining residues from the ballast tank. With the ballast water pump, filtered and disinfected sea water is guided through the injector. This driving flow, which is directed through a Laval nozzle, produces an underpressure with which residues can be drained from the ballast tanks. Both the driving flow and the ballast water from which residue is drained are fed once more to the disinfection, before the two streams are directed over board.

### 5^{th} Case: Bypass Emergency Operation

If a malfunction of one or more filters 11, 12, 13 of the disinfection C or the backwashing device should occur, the latter can be circumvented in the case of a ballast water uptake that is necessary for safety reasons. To this end, a bypass 20 runs around the entire apparatus or module.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. A water treatment water treatment plant for treating water, comprising at least one filter unit, at least one disinfecting unit, at least one detection unit and at least one control unit, said units in fluid communication, wherein the number of living organisms of per unit of volume of water can be detected by said detection unit and further wherein said disinfection unit is controlled by said control unit and said detection unit based on the number of living organisms detected.

36. The water treatment water treatment plant according to claim 35 wherein the detection unit is downstream from the disinfecting unit.

37. The water treatment water treatment plant according to claim 36 wherein the detection unit includes a fluorometer for detecting living organisms in water and wherein said fluorometer measures the minimum and maximum fluorescence relative to a unit by volume of water and further has an evaluation unit for calculating variable fluorescence and the number of living organisms of a reference species.

38. The water treatment water treatment plant according to claim 37 wherein said fluorometer has at least one light source and at least one detector.

39. The water treatment water treatment plant according claim 38 wherein the detection unit has a testing chamber that is formed by a cuvette made of glass or plastic.

40. The water treatment water treatment plant according to claim 37 wherein said detection unit has at least one pulsating light source and at least one continuous light source.

41. The water treatment water treatment plant according to claim 37 wherein said detection unit comprises at least one pulsating light source having a wavelength of approximately 420 nm.

42. The water treatment plant according to claim 37 wherein said detection unit comprises least one light source of continuous light having a wavelength of between 660 nm to at least 700 nm.

43. The water treatment plant according to claim 37 further comprising a storage unit for storing the determined number of living organisms per unit of volume of water.

44. The water treatment plant according to claim 43 wherein the storage unit is a memory device selected from the group comprising volatile and permanent.

45. The water treatment plant according to claim 37 further including an interface to a global positioning system and/or navigation system.

46. The water treatment plant according to claim 37 wherein said filter unit comprises at least two back washable filters which are arranged in a group selected from series and parallel.

47. The water treatment plant according to claim 37 wherein said filter unit comprises at least two fine filters connected in parallel with a nominal fineness of filtration of less than or equal to 50 μm,

48. The water treatment plant according to claim 37 wherein said filter unit comprises at least one hydrocyclone having a separating grain of 30 μm to 60 μm.

49. The water treatment plant according to claim 37 wherein said filter unit has at least one coarse filter, having a nominal fineness of filtration of greater than about 50 μm.

50. The water treatment plant according to claim 37 further including at least one pressure sensor for measuring pressure of the filter unit.

51. The water treatment plant according to claim 37 further comprising a means for backwashing of the filter unit when exceeding a presettable standard.

52. The water treatment plant according to claim 51 wherein the standard is selected from the group comprising pressure drop and time.

53. The water treatment plant according to claim 52 wherein said backwashing is carried out by means of a backwash pump having a backwash water pressure of about 4 bar to about 7 bar.

54. The water treatment plant according to claim 37 wherein said filter unit comprises a plurality of filters connected in parallel and further wherein each individual filter can be turned on or off with a controllable valve.

55. The water treatment plant according to claim 37 wherein said filter unit is connected to at least one controllable valve to an untreated water line and whereby the untreated water line forms a bypass when the valve is closed.

56. The water treatment plant according to claim 37 further comprising a feed pump upstream from said filter unit.

57. The water treatment plant according to claim 37 further comprising a backwash pump.

58. The water treatment plant according to claim 37 further comprising it has at least one water tank.

59. The water treatment plant according to claim 52 wherein said backwashing is carried out with water selected from the group comprising potable water, industrial water, water treatment plant-treated water and combinations thereof.

60. The water treatment plant according to claim 37 further comprising a storage tank for storing backwashed filter sludges.

61. The water treatment plant according to claim 37 further comprising at least one bypass that can be shut off.

62. The water treatment plant according to claim 37 further comprising at least one sensor arranged for measuring the volumetric flow rate in an untreated water line.

63. The water treatment plant according to claim 37 further comprising a sensor for measuring the volumetric flow rate is arranged in a water line selected from discharged water and backwash water.

64. The water treatment plant according to claim 37 wherein disinfection in said disinfection unit is carried out without the outside addition of chemicals.

65. The water treatment plant according to claim 37 wherein said disinfection unit has at least one electrolysis cell which can be controlled based on the determined number of living organisms selected from the group comprising phytoplankton cells and microorganisms.

66. The water treatment plant according to claim 37 wherein said disinfection unit has several switchable parallel strands having at least one electrolysis cell.

67. The water treatment plant according to claim 37 wherein short-lived oxidation products can be produced by means of the disinfecting unit which allows for direct introduction of treated water into the environment.

68. The water treatment plant according to claim 37 further comprising a degassing and/or ventilating device downstream from the disinfecting unit.

69. The water treatment plant according to claim 37 wherein said water treatment plant can be operated in a mode selected from the group backwash and tank-emptying and in which disinfection is carried out by said disinfecting unit or said filter unit.

70. The water treatment plant according to claim 37 wherein said plant can be operated in an emergency operation mode further comprising at least one ballast water tank wherein at said at least one ballast water tank is filled via a bypass line while by passing at least one member of the group comprising said filter unit, said disinfecting unit and said detection unit.

71. The water treatment plant according to claim 35 having a modular design wherein said filter unit, said disinfecting unit, said detection unit and combinations thereof form modules.
